(19) United States
(12) Patent Application Publication
(10) Pub. No.: US 2001/0006996 A1
(43) Pub. Date: Jul. 5, 2001

(54) Thermoplastic polymer mixtures

(76) Inventors: Joachim Queisser, Mannheim (DE); Peter Barghoorn, Kallstadt (DE)

Correspondence Address: Keil & Weinkauf, 1101 Connecticut Ave., N.W., Washington, DC, 20036, US

(21) Appl. No.: 09/734,019

(22) Filed: Dec. 12, 2000

(30) Foreign Application Priority Data
Dec. 23, 1999 (DE) 19962832.7

(51) Int. Cl. C08L 81/00; C08L 25/12

(52) U.S. Cl. 525/189

(57) ABSTRACT

Thermoplastic polymer mixtures essentially comprise copolymers (component A) formed from sulfur dioxide, from vinylaromatic compounds, from unsaturated polar compounds selected from the class consisting of compounds of the formula (I)

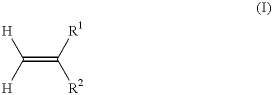

where R¹ is hydrogen or methyl and R² is CN, CHO or COOR³, where R³=hydrogen or C₁-C₂₀-alkyl, and/or from cyclic olefins having nonconjugated double bonds or from nonpolar acyclic aliphatic olefins, and comprise thermoplastic polymers (component B), and also, if desired, comprise processing aids, colorants, stabilizers, antioxidants or reinforcing materials (component C).

The present invention relates to thermoplastic polymer mixtures comprising copolymers (component A) formed from sulfur dioxide, from vinylaromatic compounds, from unsaturated polar compounds selected from the class consisting of compounds of the formula (I)

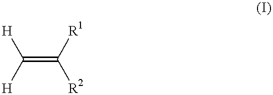

where R¹ is hydrogen or methyl and R² is CN, CHO or COOR³, where R³=hydrogen or C₁-C₂₀-alkyl, and/or from cyclic olefins having nonconjugated double bonds or from nonpolar acyclic aliphatic olefins, and comprising thermoplastic polymers (component B), and also, if desired, comprising processing aids, colorants, stabilizers, antioxidants or reinforcing materials (component C).

The invention further relates to a process for preparing these thermoplastic polymer mixtures, and also to their use for producing films, fibers or moldings.

It is known that mixtures of various polymers can be prepared in order to obtain materials which combine the advantageous properties of the individual polymers. Experiments of this type have in particular also been directed at adding suitable polymers to compensate for disadvantageous properties of polymeric materials. The application of this concept in industry is often limited by immiscibility or poor compatibility of the polymers whose properties are intended to be complementary. In these cases compatibility can be achieved, if at all, only by adding promoters specifically tailored to the particular polymer mixture. These compatibilizers are mostly complicated to prepare and moreover can have a lasting effect on the desired property profile of the intended polymer mixture. A major factor which inhibits the homogeneous mixing of different polymers is that the mixing of high-molecular-weight molecules generally gives only a very small entropy of mixing, which is not able to compensate for the positive enthalpy of mixing. The few polymer mixtures which can be mixed without further additives include blends made from poly(styrene-co-acrylonitrile) and polymethyl methacrylate, and also polystyrene and polyphenylene ether (see also Kunststoff Taschenbuch, H. Saechtling, 26^{th} edition, Carl Hanser Verlag Munich, 1995).

A disadvantage freqeuntly found in thermoplastic polymers is that their heat resistance is insufficient for high-temperature applications. To obtain materials with high temperature resistance attempts have been made, inter alia, to use suitable compounds to replace monomer components in conventional polymers. Foe example, partial or full replacement of styrene in poly-(styrene-co-acrylonitrile) by α-methylstyrene gives a copolymer with increased heat resistance. A disadvantage is that this copolymer is immiscible with conventional poly(styrene-co-acrylonitrile). Incorporating phenylmaleimide into the fundamental structure of the poly(styrene-co-acrylonitrile) also increases the heat resistance. However, this is associated with embrittlement of the material, which in addition acquires an intrinsic color. The preparation process for these latter compounds is, furthermore, generally very complicated.

It would be desirable to be able to utilize polymer mixtures whose components can be obtained simply and at low cost and which can be prepared simply and have high dimensional stability, in particular at high temperatures, together with good other mechanical and rheological properties.

It is an object of the present invention, therefore, to provide polymer mixtures with a good mechanical property profile, even at elevated temperatures, and which, furthermore, are simple to obtain and have good rheological behavior.

We found that this object is achieved by polymer mixtures comprising copolymers (component A) formed from sulfur dioxide, from vinylaromatic compounds, from unsaturated polar compounds selected from the class consisting of compounds of the formula (I)

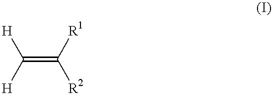

where R¹ is hydrogen or methyl and R² is CN, CHO or COOR³, where R³=hydrogen or C₁-C₂₀-alkyl, and/or from cyclic olefins having nonconjugated double bonds or from nonpolar acyclic aliphatic olefins, and comprising thermoplastic polymers (component B), and also, if desired, comprising processing aids, colorants, stabilizers, antioxidants or reinforcing materials (component C). A process for preparing thermoplastic polymer mixtures has also been found, as has their use for producing films, fibers or moldings.

Suitable SO₂-containing copolymers are those which have an aliphatic main chain (component A). Possible comonomers, besides sulfur dioxide, are in particular vinylaromatic compounds and polar olefinically unsaturated cyclic or acyclic comonomers, such as (meth)acrylic acid, esters and amides of (meth)acrylic acid, (meth)acryonitrile or (meth)acrolein. For the purposes of the resent invention, suitable SO₂ copolymers include binary, ternary, tetrameric or higher copolymer systems. The individual copolymer units may have a random distribution, or alternate or be in the form of block segments in the copolymer. Ternary SO₂ copolymers are preferably utilized.

Suitable vinylaroamtic comonomers are in principle any mono- or polynucleic aromatic compound which has one or more vinyl groups. The aromatic ring systems in these compounds may also be heteroaryl and contain, for example, one or more heteroatoms such as O, S and/or N as ring atoms. The ring systems may moreover have substitution by any desired functional groups. Preferred vinylaromatic compounds are mono- or binuclear aromatic or heteroaromatic ring systems made from from 5 to 10 ring atoms, having 0, 1, 2 or 3 heteroatoms and either unsubstituted or alkyl- or halo-substituted. Preferred heteroatom is nitrogen. Examples of suitable heteroaromatic vinyl compounds are 2-vinylpyridine and 4-vinylpyridine. Suitable polynuclear vinylaromatic compounds are 4-vinylbiphenyl and 4-binylnaphthalene.

Particular vinylaromatic comonomers are compounds of the formula (II)

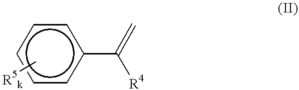

where R⁴ is hydrogen, C₁-C₈-alkyl or halogen and R⁵ is C₁-C₈-alkyl or halogen and k is 0, 1, 2 or 3. Particularly suitable vinylaromatic compounds (II) are styrene, α-methylstyrene, o-, m- or p-methylstyrene, p-ethylstyrene, 3-vinyl-o-xylene, 4-vinyl-o-xylene, 2-vinyl-m-xylene, 4-vinyl-m-xylene, 5-vinyl-m-xylene, 2-vinyl-p-xylene, 1,4-divinylbenzene, diphenylethylene or any desired mixture of the abovementioned vinylaromatic compounds. Particular preference is given to the use of α-methylstyrene and styrene as vinylaromatic comonomers, and styrene is very particularly preferred.

It is, of course, also possible to use any desired mixture of vinylaromatic comonomers.

Suitable polar unsaturated comonomers include compounds of the formula (I)

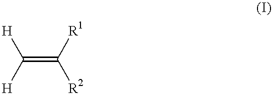

where R¹ is hydrogen or methyl and R² is CN, CHO or COOR³, where R³=hydrogen or C₁-C₂₀-alkyl.

Examples of suitable polar olefinically unsaturated comonomers are vinyl cyanides, such as acrylonitrile or methacrylonitrile, (meth)acrylic acid, C₁-C₂₀-alkyl or C₆-C₁₅-aryl (meth)acrylates or mixtures of these. Particularly suitable (meth)acrylates are methyl, ethyl, propyl, n-butyl, tert-butyl, 2-ethylhexyl, glycidyl and phenyl (meth)acrylate. Particular preference is given to acrylic acid, methacrylic acid, methyl, ethyl, propyl, n-butyl, tert-butyl and 2-ethylhexyl acrylate, and also to methyl methacrylate, acrylonitrile, vinyl acetate and acrolein, and mixtures of these. Acrylonitrile in particular is utilized as polar unsaturated comonomer.

Other suitable comonomers, instead of or alongside the polar α-olefins, are cyclic olefins having nonconjugated double bonds. These compounds may have two or more nonconjugated double bonds. Examples of suitable compounds are 1,4-cyclohexadiene, 1,4-cycloheptadiene, 1,4-cyclooctadiene, 1,5-cyclooctadiene, norbornadiene, 5-ethylidene-2-norbornene or mixtures of these. 1,5-Cyclooctadiene is particularly preferred.

If desired, use may also be made of linear or branched olefins, in particular α-olefins, as acyclic aliphatic nonpolar comonomers, for example ethene, propene, 1-butene, isobutene, 1-hexene, 1-octene or 1-dodecene or mixtures of these. It is, of course, also possible to use mixtures of the abovementioned unsaturated nonpolar compounds.

Suitable binary SO₂ copolymers contain in particular a vinylaromatic compound, preferably styrene, as a further comonomer alongside SO₂. These copolymers, and their preparation, are described, for example, in U.S. Pat. No. 2,572,185. Binary copolymers of component A) may also be based on sulfur dioxide and olefinically unsaturated polar comonomers, in particular acrylates, e.g. as described in Tsonis et al., Makromol. Chem. Rapid Commun., 1989, 10, 641-644. Examples of suitable binary sulfur dioxide copolymers based on olefinically unsaturated nonpolar compounds are disclosed, for example, in U.S. Pat. No. 3,331,819. Finally, reference may also be made to Enomoto et al., Bull. Chem. Soc. Jap., 1971, 44, 3140-3143, Matsuda et al., Macromolecules, 1972, 5, 240-246, and also Cais et al., Macromolecules, 1977, 254-260, for the preparation of SO₂-styrene copolymers by free-radical polymerization in bulk or solution.

It is preferable for ternary SO₂ copolymers to be used as component A) in the novel polymer mixtures. Preferred ternary copolymers contain, besides sulfur dioxide, a vinylaromatic compound, preferably styrene, as a comonomer unit. Olefinically unsaturated nonpolar compounds, in particular nonconjugated cycloolefins, or olefinically unsaturated polar compounds, in particular acrylates, vinyl acetate, acrolein or acrylonitrile, are also possible comonomers. Preference is given to ternary copolymers based on sulfur dioxide, on vinylaromatic comonomers, in particular styrene, and on acrylonitrile or acrylates, such as methyl, butyl or ethylhexyl acrylate.

The proportion of sulfur dioxide incorporated into the terpolymer is usually from 1 to 50 mol % and preferably from 3 to 40 mol %, based on the copolymer A). The proportion of vinylaromatic compounds is generally from 1 to 98 mol % and preferably from 10 to 92 mol %. The proportion of olefinically unsaturated polar and/or nonpolar compound is normally from 1 to 50 mol % and preferably from 5 to 40 mol %.

For the purposes of the present invention, SO₂ copolymers also include copolymers which contain sulfur dioxide, vinylaroamtic compounds, and also nonpolar and polar olefinically unsaturated compounds as comonomer units, for example a copolymer containing SO₂, a vinylaromatic compound, such as styrene or α-methylstyrene, acrylonitrile, n-butyl acrylate or methyl methacrylate as polar olefinically unsaturated compound and, for example, 1,5-cyclooctadiene or ethene, propene or 1-butene as nonpolar olefin.

A process for preparing suitable SO₂ copolymers will be decribed in more detail below by way of example. In this process, sulfur dioxide and all of the other comonomer units are polymerized by a free-radical route in suspension, bulk, solution or emulsion at from −80 to 250° C. The polymerization may be carried out either thermally or using a free-radical chain initiator.

The initial molar ratio of sulfur dioxide to olefinically unsaturated compounds, i.e. the total amount of comonomer units used other than sulfur dioxide, is usually from 20:1 to 1:20, preferably from 10:1 to 1:10 and particularly preferably from 5:1 to 1:5.

In the case of the preferred terpolymers or higher copolymers, the initial molar ratio of vinylaromatic comonomer to the other olefinically unsaturated compounds may be varied within a wide range and be from 50:1 to 1:50, preferably from 5:1 to 1.1:1, and particularly preferably from 3:1 to 1.1:1.

The free-radical chain initiators used may comprise organic or inorganic peroxide or hydroperoxides, such as potassium peroxodisulfate or sodium peroxodisulfate, percarbonates, azo compounds and/or compounds having labile C—C single bonds. Use may also be made of redox systems, e.g. a system composed of cumene hydroperoxide, iron(III)-EDTA complex and Rongalit®C. It is also possible to use substances which form redox systems with sulfur dioxide. Other free-radical polymerization initiators which may be used are monomers which polymerise spontaneously at elevated temperatures, e.g. styrene.

Suitable peroxides or hydroperoxides are dibenzoyl peroxide, lauroyl peroxide, 2,4-dichlorobenzoyl peroxide, bis(4-tert-butylcyclohexyl) peroxydicarbonate, tert-butyl peroxypivalate, hydrogen peroxide, cumene peroxide, tert-butyl hydroperoxide, peracetic acid and dicetyl peroxydicarbonate (e.g. Perkadox 24®). Particularly suitable azo compounds are 2,2′-azobis(isobutyronitrile) (AIBN) and 2,2′-azobis (2-methylbutyronitrile). Compounds having labile C—C bonds and whose use is preferred are 3,4-dimethyl-3,4-diphenylhexane and 2,3-dimethyl-2,3-diphenylbutane. Preferred substances which form redox systems with sulfur dioxide are chlorates, perchlorates, persulfates, and nitrates, such as silver nitrate, lithium nitrate and ammonium nitrate.

Other suitable free-radical chain initiators are oxygen, ozonides, trimethylamine oxide, dimethylaniline oxide, 2,2,6,6-tetramethylpiperidinyloxy (TEMPO) and its derivatives, N₂O and NO₂.

It is also possible to use mixtures of the free-radical chain initiators mentioned.

The amount of free-radical chain initiator used is usually from 0.01 to 10% by weight, preferably from 0.1 to 5% by weight, based on the amount of comonomers used. These quantity data do not of course relate to cases where a monomer is initiator and is thermally initiated, as is possible with the comonomer system SO₂/styrene, for example.

In bulk polymerization the monomers are polymerized without addition of any other reaction medium, using the monomer-soluble initiators mentioned, i.e. monomers are the reaction medium. Thermal initiation is also possible.

The solution polymerization differs from the bulk polymerization primarily in that there is concomitant use of an organic solvent to dilute the monomers. Examples of suitable solvents are aliphatic or aromatic hydrocarbons, such as pentane, hexane, heptane, ligroin, cyclohexane, benzene, ethylbenzene, toluene, xylene, alcohols, such as methanol, ethanol, n-propanol, isopropanol, n-butanol and isobutanol, ethers, such as diethyl ether, p-dioxane, halogenated hydeocarbons, such as dichloromethane, chlorobenzene and o-dichlorobenzene, and also sulfolane, dimethyl sulfoxide, pyridine, dimethylformamide, N-methylpyrrolidone, cyclohexanone, acetone, water, phenol, cresol and acetonitrile. Preferred solvents are dichloromethane, toluene and ethylbenzene. The free-radical chain initiators mentioned may also be used in the solution polymerization, or thermal initiation may be used.

To carry out the present process, SO₂, the vinylaromatic compound and an unsaturated polar and/or nonpolar compound, if desired together with a solvent and, if desired, with a free-radical chain initiator are placed in a reaction vessel. It is also possible for individual components to form an initial charge, for example the vinylaromatic compound, the unsaturated polar or nonpolar compound or the free-radical chain initiator, and for the components not yet present, for example SO₂, then to be added. The components mentioned may be gaseous or liquid.

Suitable reaction vessels for continuous operation of the present process are tubular reactors, loop reactors, (continuous) stirred-tank reactors and cascades of stirred reactors. Examples of reaction vessels suitable for batch operation, which is also possible, are stirred autoclaves and steel ampules.

To obtain reproducibly good productivity it is preferable for the reaction mixture to be mixed intensively. For this, use may be made of suitable stirring devices, such as anchor stirrers, disc agitators, blade stirrers or helical stirrers. Suitable stirring rates are from 5 to 1100 rpm, preferably more than 10 rpm.

The polymerization is carried out at from −80 to 250° C., preferably from 0 to 190° C., particularly preferably from 10 to 170° C.

The polymerization may in principle be carried out at subatmospheric pressure, at atmospheric pressure or at superatmospheric pressure. The pressure is usually set at from 1 to 300 bar, preferably from 2 to 30 bar.

The polymerization time may be from 15 minutes to 10 days, preferably from 30 minutes to 24 hours, particularly preferably from 1 to 10 hours.

The reaction may be terminated by adding free-radical scavengers, e.g. quinones, hydroquinones, benzothiazine or diphenylpicrylhydrazyl, 2,2,6,6-tetramethylpiperidine-N-oxyl, diethylhydroxylamine or sterically hindered phenols.

Once the polymerization has finished, the polymer formed is either isolated directly, for example by removing the solvent by means of heat and/or in vacuo, filtration or—if necessary—first precipitated by introducing the reaction mixture into a solvent in which the polymer is insoluble, and then isolated. Finally, the polymer may be dried at an elevated temperature. Excess monomers and solvent may be removed in vacuo.

The molecular weights of the SO₂ copolymers prepared by the novel process may be varied over a wide range by an appropriate choice of the process parameters. It is also possible here to use regulators during the reaction, for example halohydrocarbons, mercaptans, dimeric α-methylstyrene, terpenes, Co(II) complexes or ethylbenzene. The molar masses usually obtained are from 20,000 to 1,000,000 g/mol. The polydispersity M_{w}/Mₙ is usually from 1 to 5. SO₂ copolymers from the process described usually have glass transition temperatures above 110° C., even up to 200° C. This generally means that high softening points are achieved for moldings. The copolymers obtained are moreover very heat-resistant. These polymers usually have little or no weight loss even when annealed for a number of hours at 200° C. or above.

The amount of component A) present in the novel polymer mixtures is from 1 to 99% by volume, preferably from 5 to 95% by volume and particularly preferably from 20 to 80% by volume.

The sulfur dioxide copolymers (component A) mentioned form novel polymer mixtures with thermoplastic polymers (component B). Suitable thermoplastics are in principle any of the known polymers or polymer mixtures in this class of compound. A feature of compounds in this class is that the materials can be processed by thermoplastic methods. Examples of suitable thermoplastic polymers are polyalkyl methacrylates, polystyrene, polyamides, polycarbonates, polyesters, polysulfones, poly(ether) sulfones, polyurethanes, polyvinyl chloride, polyolefins, such as polyethylene and polypropylene, polyphenylene ethers, polyacetals, polyacrylonitrile, styrene (co)polymers, e.g. poly(styrene-co-acrylonitrile), or rubber-modified styrene (co)polymers, e.g. polymers based on the monomers styrene, acrylonitrile and butadiene or styrene, acrylonitrile and an acrylate (known as ABS and, respectively, ASA copolymers).

Suitable styrene (co)polymers include polystyrene impact-modified by polybutadiene rubbers, for example high-impact polystyrene (HIPS), and also styrene (co)polymers with acrylonitrile as comonomer component, for example polystyrene-acrylonitrile (abbreviated to SAN). It is, of course, also possible for the novel polymer mixtures to be blended with rubber-modified styrene (co)polymers prepared preferably in bulk or emulsion. This category includes styrene-acrylonitrile copolymers modified by polybutadiene, for example the material known as ABS, styrene-acrylonitrile copolymers modified by polybutyl acrylate, for example using the material known as ASA, and styrene-acrylonitrile copolymers modified by ethylene-propylene-diene (EPDM) copolymer, for example the material known as AES. The respective rubbers here are usually present in dispersed particulate form in the styrene copolymer matrix. The ABS and ASA blends preferably involve graft copolymers. They comprise a hard matrix which essentially comprises SAN, and also a particulate graft rubber dispersed in the matrix. In the case of ABS the rubber comprises a core based on polybutadiene, grafted with an SAN shell, and in that case of ASA the core is based on crosslinked polyalkyl acrylate (in particular polybutyl acrylate), grafted with an SAN shell. The SAN shell may have been built up in one or more stages. For example, it may have a first (inner) stage made from styrene homopolymer and a second (outer) stage made from styrene-acrylonitrile copolymer, and the transition between the stages may be sharp or blurred (= progressive). The core may also have been built up in one or more stages. In particular, it may have an inner stage made from styrene homo- or copolymer and an outer stage made from polybutadiene (in the case of ABS) or polyalkyl acryalte (in the case of ASA) (see also Kunststoff Taschenbuch, H. Saechtling, 26^{th} edition, Carl Hanser Verlag Munich, 1995).

The styrene (co)polymers described, if desired impact-modified, are preferably prepared by solution or bulk polymerization or by combined bulk and solution polymerization. Particular preference is given to solution polymerization. Further details of the polymerization processes mentioned may be found by the skilled worker in “Ullmann's Encyclopedia of Industrial Chemistry”, 5^{th} edition, Vol. A21, Ed. Elvers et al., VCH Verlag, Weinheim 1992, Section 3.3.3=pp. 355-393, and “Handbuch der Technischen Polymerchemie” by A. Echte, VCH Verlag, Weinheim 1993, Section 8.3=pp. 475-492.

It is also possible to use any desired mixture of the above-mentioned thermoplastic polymers. Among the polymer mixtures, particular preference is given to those made from polymethyl methacrylate and poly(styrene-co-acrylonitrile), from a styrene-acrylonitrile copolymer modified by an acrylate rubber, e.g. ASA, and in particular a styrene-acrylonitrile copolymer modified by a butadiene rubber, e.g. ABS, and polyamide, such as that obtainable with the tradename Stapron®N (BASF AG), from a styrene-acrylonitrile copolymer modified by a butadiene rubber, e.g. ABS, or from a styrene-acrylonitrile copolymer modified by an acrylate rubber, e.g. ASA, and polycarbonate, such as that obtainable with the tradename Luran®SC (BASF AG), or else from a styrene-acrylonitrile copolymer modified by a butadiene rubber, e.g. ABS, or in particular from a styrene-acrylonitrile copolymer modified by an acrylate rubber, e.g. ASA, and polybutylene terephthalate, such as that obtainable with the tradename Ultradur®S (BASF AG).

Other suitable mixtures are those composed of polyvinyl chloride and ASA, and also in particular ABS. Other possible mixtures are those made from polymethyl methacrylate and styrene/acrylonitrile copolymer as hard component and from a soft component based on polybutadiene or on a styrene-butadiene copolymer rubber, where the soft component has been grafted with styrene and acrylonitrile, as described in DE-A 28 28 517, for example. Mixtures particularly suitable in this connection are those in which the soft component comprises graft copolymers having a polybutadiene backbone or a styrene-butadiene block copolymer backbone and lateral grafted-on branches made from (meth)acrylates, in particular methyl methacrylate, and, if desired, vinylaromatic compounds, in particular styrene. EP-A 062 223 is expressly incorporated herein by way of reference with regard to the preparation and properties of the latter mixture. These mixtures are also obtainable commercially with the tradename Terlux® (BASF AG).

Examples of suitable polycarbonates are those based on biphenols of the formula (III)

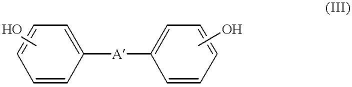

where A′ is a single bond, C₁-C₃-alkylene, C₂-C₃-alkylidene or C₃-C₆-cycloalkylidene or S or SO₂.

Examples of preferred biphenols of the formula (III) are 4,4′-dihydroxydiphenyl, 2,2-bis(4-hydroxyphenyl)propane (bisphenol A), 2,4-bis(4-hydroxyphenyl)-2-methylbutane and 1,1-bis(4-hydroxyphenyl)cyclohexane. Other preferred biphenols are hydroquinone and resorcinol. Particular preference is given to 2,2-bis(4-hydroxyphenyl)propane, 2,2-bis(4-hydroxyphenyl)cyclohexane, 2,2-bis(4-hydroxyphenyl)-2,3,5-trimethylcyclohexane and 2,2-bis(4-hydroxyphenyl)-3,3,5-trimethylcyclohexane.

Suitable polyesters are likewise known and described in the literature (see also Kunststoffhandbuch 3/1). They generally derive from an aromatic dicarboxylic acid, and the aromatic skeleton may have substitution with halogen, such as chlorine or bromine, or with straight-chain or branched alkyl, preferably C₁-C₄-alkyl. Preferred dicarboxylic acids are naphthalenedicarboxylic acid, terephthalic acid and isophthalic acid, and dicarboxylic acids which may have a certain extent (generally up to 10 mol %) of replacement by aliphatic or cycloaliphatic dicarboxylic acids. A particularly suitable polyester component is polybutylene terephthalate. The viscosity number of the polyesters is generally from 60 to 200 ml/g (measured in 0.5% strength by weight solution in a phenol/o-dichlorobenzene mixture).

Examples of suitable polyacetals are polyoxymethylenes, such as the commercially available product Ultraform® (Ultraform GmbH).

Suitable polycarbonates, polyacetals and polyesters, and also processes for their preparation, may be found in Kunststoff-Handbuch 3/1 “Technische Thermoplaste, Polycarbonate, Polyacetale, Polyester, Celluloseester”, Ed. L. Bottenbruch, Hanser-Verlag, Munich, 1992, 117-299.

Suitable polyamides are known per se. It is very generally preferable to use polyamides whose structure is aliphatic and semicrystalline or partly aromatic and amorphous. Polyamide blends may also be used. Suitable polyamides are obtainable, for example, with the tradename Ultramid® (BASF AG).

Examples of poly(ether) sulfones are compounds such as the product with the trademark Ultrason® E or S (BASF AG). Examples of suitable polysulfones are described, inter alia, by F. Zahradnik, “Hochtemperatur-Thermoplaste”, VDI Verlag GmbH, Dusseldorf, 1993.

Polyalkyl methacrylates include in particular polymethyl methacrylate, and also the copolymers based on methyl methacrylate with up to 40% by weight of other copolymerizable monomer, preferably C₁-C₄-acrylates. An example of the preparation of these polymeric materials is bulk, emulsion, solution or suspension polymerization methyl methacrylate (MMA) or MMA mixtures comprising preferably up to 20% by weight of comonomers. Examples of suitable comonomers are methyl, ethyl and butyl acrylate. The polymerization is usually carried out by a free-radical route, preferably at from 40 to 150° C., or by an anionic route at low temperature, or by a coordinative route using transition metal catalysts. PMMA polymerized by a free-radical or coordinative route preferably comprises products with particular steric configurations. Bulk products are usually prepared by bulk, solution or suspension processes. The skilled worker can find more detail in H. Raudi-Puntigam, T. Völker: Chemie, Physik und Technologie der Kunststoffe in Einzeldarstellungen, Vol. 9: Acryl- und Methacrylverbindungen, Springer-Verlag 1967, for example. An example of a suitable polyalkyl methacrylate is that marketed with the trademark Lucryl® (Barlo Plastics GmbH).

The abovementioned thermoplastic polymers are, like polyvinyl chloride, polyolefins, polyphenylene ethers, polyurethanes and polyacrylonitrile, in any case well known to the skilled worker. In connection with the preparation and properties of the polymers B), the following publications are expressly incorporated herein by way of reference: W. Hellerich, Werkstoff-Fuhrer Kunststoffe, Eigenschaften, P\ddot{ru}fung, Kennwerte, 7^{th} Edn. Carl Hanser Verlag, Munich, 1996, pp. 66-128, and also L. Bottenbruch, “Technische Thermoplaste, Hochleistungs-Kunststoffe”, Kunststoff-Handbuch 3/3, Carl Hanser Verlag, Munich, 1994, and A. Echte, “Handbuch der Technischen Polymerchemie”, VCH Verlag, Weinheim, 1993.

Preference is given to polymer mixtures based on sulfur dioxide terpolymers comprising SO₂, a vinylaromatic compound, in particular styrene, and a polar olefinically unsaturated compound, in particular acrylonitrile, and a thermoplastic polymer, as described above. Among the thermoplastic polymers particular preference is given in this case to styrene (co)polymers, in particular impact-modified or rubber-modified styrene (co)polymers.

The proportion of thermoplastic polymer in the novel polymer mixture is generally from 1 to 99% by volume, preferably from 5 to 95% by volume and particularly preferably from 20 to 80% by volume.

The novel polymer mixtures may also comprise, based on the mixture made from components A) and B) up to 50% by volume, preferably from 0.001 to 40% by volume and in particular from 0.01 to 35% by volume, of customary additives, e.g. processing aids, colorants, stabilizers, antioxidants or reinforcing materials (component C).

In another preferred embodiment the proportion of component A) is from 1 to 98.999% by volume, preferably from 5 to 98.995% by volume, that of component B) is from 1 to 98.999% by volume, preferably from 5 to 98.99% by volume, and that of component C) is from 0.001 to 40% by volume, preferably from 0.01 to 35% by volume.

Possible inorganic fillers are fibrous or particulate materials, such as carbon fibers, glass fibers, glass beads, amorphous silicas, asbestos, calcium silicate, calcium metasilicate, magnesium carbonate, kaolin, chalk, powdered quartz, mica, barium sulfate and feldspar, preferably at from 1 to 40%, particularly preferably at from 20 to 35% by volume.

Oxidation retarders or antioxidants, and also heat stabilizers, which may be used are alkylphenols, in particular sterically hindered phenols, hydroxyphenyl propionates, hydroxybenzyl compounds, alkylidenebisphenols, hydroquinones, secondary aromatic amines, such as diphenylamine, thiobisphenols, aminophenols, thio ethers, organic phosphites, hypophosphites and phosphonites, inorganic phosphites, inorganic hypophosphites, e.g. metal salts of phosphorous acid H₃PO₃ or of hypophosphorous acid H₃PO₂, in particular the phosphites of alkali metals or of alkaline earth metals, and hypophosphites of alkali metals or of alkaline earth metals, for example calcium phosphite CaHPO₃, sodium hypophosphite NaH₂PO₂ or potassium hypophosphite KH₂PO₂, or else mixtures of these, at concentrations of up to 5% by volume, preferably from 0.03 to 3% by volume and particularly preferably from 0.05 to 1% by volume, based on the volume of the thermoplastic polymer mixture.

Preferred antioxidants are sterically hindered phenols, in particular those which contain an ester group, organic phosphites and phosphonites, in particular triaryl phosphites and triaryl phosphonites, e.g. triphenyl phosphite and triphenyl phosphonite, and in particular also mixtures of these.

All of the antioxidants mentioned are known and available commercially.

Examples of suitable UV stabilizers or light stabilizers are resorcinol and substituted resorcinols, salicylates, benzotriazoles, benzophenones, sterically hindered phenols, sterically hindered amines, in particular tetraalkylpiperidine-N-oxy compounds, e.g. those known as HALS compounds, phosphites and nickel- or sulfur-containing compounds, and also mixtures of these. Mixtures made from benzotriazoles with sterically hindered amines are particularly preferred. All of the UV stabilizers and, respectively, light stabilizers mentioned are known and commercially available.

Examples of sterically hindered phenols are bis(2,6-tert-butyl)-4-methylphenol (BHT), 4-methoxymethyl-2,6-di-tert-butylphenol, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 2,4-di-tert-butylphenyl 3,5-di-tert-butyl-4-hydroxybenzoate, 2,2-bis(4-hydroxyphenyl)propane (bisphenol A), 4,4′-dihydroxybiphenyl (DOD), 2,2′-methylenebis(4-methyl-6-tert-butylphenol), 1,6-hexanediol bis-(3-(3,5-di-tert-butyl-4-hydroxyphenyl)propionate), octadecyl 3-(3,5-bis(tert-butyl)-4-hydroxyphenyl)propionate, 3,5-di-tert-butyl-4-hydroxybenzyldimethylamine, 2,6,6-trioxy-l-phosphabicyclo[2.2.2]oct-4-ylmethyl 3,5-di-tert-butyl-4-hydroxyhydrocinnamate and N,N′-hexamethylenebis(3,5-di-tert-butyl-4-hydroxycinnamide). Among the sterically hindered phenols mentioned, preference is given to bis(2,6-(C₁-C₁₀-alkyl)-4-(C₁-C₁₀-alkyl)phenols, in particular bis(2,6-tert-butyl)-4-methylphenol and bis(2,6-methyl)-4-methylphenol.

Examples of sterically hindered amines are 2,2,6,6-tetramethyl-1-piperidinyloxy (TEMPO), 4-oxo-2,2,6,6-tetramethyl-1-piperidinyloxy (4-oxo-TEMPO), 4-hydroxy-2,2,6,6-tetramethyl-1-piperidinyloxy, 2,2,5,5-tetramethyl-1-pyrrolidinyloxy, 3-carboxy-2,2,5,5-tetramethylpyrrolidinyloxy, 2,6-diphenyl-2,6-dimethyl-1-piperidinyloxy, and also 2,5-diphenyl-2,5-dimethyl-1-pyrrolidinyloxy. It is, of course, also possible to use mixtures of the abovementioned compounds. Particularly preferred HALS compounds are bis(2,2,6,6-tetramethyl-4-piperidyl) sebacate and bis(2,2,6,6-tetramethyl-N-methyl-4-piperidyl) sebacate, which are obtainable commercially with the trademarks Tinuvin®770 and, respectively, Tinuvin®765. A preferred triazole compound is 2-(2′-hydroxy-5′-methylphenyl)benzotriazole (Tinuvin®P).

The amounts used of the light stabilizers are up to 2% by volume, based on the polymer mixture. If more than one light stabilizer is used, the abovementioned amounts are the total amount.

Use may also be made of inorganic pigments, e.g. titanium dioxide, ultramarine blue, iron oxide or carbon black, or of organic pigments, such as phthalocyanines, quinacridones, perylenes, or of dyes, e.g. nigrosine or anthraquinones.

Lubricants and mold-release agents whose use is preferred are long-chain fatty acids, e.g. stearic acid, salts thereof, e.g. magnesium stearate, calcium stearate or zinc stearate, or montan waxes (mixtures made from straight-chain, saturated carboxylic acids having chain lengths of from 28 to 32 carbon atoms), and also low-molecular-weight polyethylene waxes or low-molecular-weight polypropylene waxes.

The novel polymer mixtures may be prepared by mixing processes known per se, generally at from 150 to 350° C., for example by melting in an extruder, Banbury mixer or kneader, or on a roll mill or calender. The components may also be mixed cold, without melting, and the mixture, composed of powder or of pellets, not melted and homogenized until it is processed.

The novel polymer mixtures feature very good mechanical properties, in particular very good heat distortion temperatures. These are generally above 110° C., and values above 140° C. may also readily be obtained. The polymer mixtures also feature good stiffness, i.e. a high modulus of elasticity, and good softness, and also good flowability. The novel polymer mixtures also retain their good mechanical properties, even when subjected to long-term stressing at elevated temperatures. The novel polymer mixtures are also easy to obtain, even on an industrial scale. The same applies to the starting polymers used.

The examples below further illustrate the present invention without limiting the same.

### EXAMPLES

The thermal properties of the polymers were determined by differential scanning calorimetry (DSC) (determining the glass transition temperature T_{g}) or differential thermogravimetry (DTG) (determining the thermal stability, the DTG peak determined under nitrogen being given). The heating rate for nonisothermal studies by DSC or DTG was 10 K/min unless otherwise stated.

The average molar masses M_{w} and Mₙ were determined by gel permeation chromatography (GPC) with tetrahydrofuran as solvent, by comparison with polystyrene standards.

The proportions given for the monomer units in the polymer chain were determined by ¹³C NMR in chloroform, and also by elemental analysis.

Poly(styrene-co-acrylonitrile-co-SO₂) with various SO₂ contents was used as component A. The specimen accordingly contained

A₁) 7.0 (M_{w}=221,700 g/mol, D=M_{w}/Mₙ=4.15),

A₂) 8.1 (M_{w}=173,300 g/mol, D=3.06),

A₃) 12.3 (M_{w}=234,000 g/mol, D=5.74),

A₄) 14.8 (M_{w}=467,500 g/mol, D=4.30), and

A₅) 24.7 mol % (M_{w}=110,500 g/mol, D=1.51) of SO₂.

A poly(styrene-co-acrylonitrile) with 33% by weight of acrylonitrile content (B₁), and also a poly(styrene-co-acrylonitrile) with 25% by weight acrylonitrile content (B₂) were used as component B).

To prepare the polymer mixtures, the individual components were in each case dissolved in 2-butanone at 50° C., mixed with one another with stirring and precipitated by adding excess methanol at room temperature. The polymeric product isolated was freed from the last residues of solvent at 80° C. under high vacuum.

Table 1 below shows the extent to which components A) and B) are homogeneously miscible.

TABLE 1
Glass transition temperatures for mixtures
(1:1; volume/volume) made from components A) and B)

| Polymer mixture ^{a)} | T_{g} [° C.] ^{b)} |
|---|---|
| A₁ + B₁ | 120 (122) |
| A₂ + B₁ | 122 (125) |
| A₃ + B₁ | 124 (131) |
| A₄ + B₁ | 125 (139) |
| A₅ + B₁ | 130 (167) |
| B₁ | 112 |

^{a)} The polymer mixtures was heated to 180° C., held at this temperature for 10 min and then tested over the range from 60 to 200° C. with a heating rate of 20° C./min;
^{b)} The bracketed values give the T_{g} of each of the pure SO₂ terpolymers used.

Table 2 below gives glass transition temperatures as a function of the proportion of component A₂). Component B₁) was used as thermoplastic polymer.

TABLE 2

| A₂ + B₁ ^{a)b)} | T_{g} [° C.] |
|---|---|
| 25/75 | 118 |
| 50/50 | 126 |
| 75/25 | 124 |
| 100/0 | 134 |
| 0/100 | 112 |

^{a)} Data in % by volume.
^{b)} The specimens were heated to 260° C., annealed at this temperature for 10 min and then tested over the range from 60 to 200° C. at a heating rate of 20° C./min.

Table 3 below shows the mixing behavior of components A₁) to A₅) in component B₂).

TABLE 3

| Polymer mixture ^{a)} | T_{g} [° C.] ^{b)} |
|---|---|
| A₁ + B₂ | 118 |
| A₂ + B₂ | 120 |
| A₃ + B₂ | 113 + (133) |
| A₄ + B₂ | 113 + (140) |
| A₅ + B₂ | 116 + (143) |
| B₂ | 112 |

^{a)} in each case the mixtures comprise 50% by volume of A) and 50% by volume of B).
^{b)} The specimens were heated to 260° C., annealed at this temperature for 10 min and then tested over the rate from 60 to 200° C. at a heating rate of 20° C./min.

We claim:

1. A thermoplastic polymer mixture comprising copolymers (component A) formed from sulfur dioxide, from vinylaromatic compounds, from unsaturated polar compounds selected from the class consisting of compounds of the formula (I) 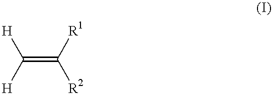
where R¹ is hydrogen or methyl and R² is CN, CHO or COOR³, where R³=hydrogen or C₁-C₂₀-alkyl, and/or from cyclic olefins having nonconjugated double bonds or from nonpolar acyclic aliphatic olefins, and comprising thermoplastic polymers (component B), and also, if desired, comprising processing aids, colorants, stabilizers or reinforcing materials (component C).

2. A thermoplastic polymer mixture as claimed in claim 1, wherein component A) is a ternary copolymer made from sulfur dioxide, from a vinylaromatic compound and from a polar olefinically unsaturated compound (I).

3. A thermoplastic polymer mixture as claimed in claim 1 or 2, wherein component A) is poly(styrene-co-acrylonitrile-co-SO₂).

4. A thermoplastic polymer mixture as claimed in any of claims 1 to 3, wherein component B) is polyalkyl methacrylates, polystyrene, polyamides, polycarbonates, polyesters, polysulfones, poly(ether) sulfones, polyurethanes, polyvinyl chloride, polyolefins, such as polyethylene and polypropylene, polyphenylene ethers, polyacetals, polyacrylonitrile, styrene (co)polymers or rubber-modified styrene (co)polymers or any desired mixture of the abovementioned compounds.

5. A thermoplastic polymer mixture as claimed in any of claims 1 to 4, wherein the proportion of
component A) is from 1 to 99% by volume,
component B) is from 1 to 99% by volume, and
component C) is from 0 to 40% by volume,
based in each case on the total volume of the thermoplastic polymer mixture, where the total of the percentages by volume is always 100.

6. A thermoplastic polymer mixture as claimed in any of claims 1 to 4, wherein the proportion of
component A) is from 1 to 98.999% by volume,
component B) is from 1 to 98.999% by volume, and
component C) is from 0.001 to 40% by volume,
based in each case on the total volume of the thermoplastic polymer mixture, where the total of the percentages by volume is always 100.

7. A process for preparing the polymer mixtures as claimed in any of claims 1 to 6, which comprises mixing components A) and B) and, if used, component C), without prior melting and homogenizing the resultant mixture during processing, or comprises mixing the components at an elevated temperature with melting.

8. The use of the polymer mixtures as claimed in any of claims 1 to 6 for producing fibers, films or moldings.
